(19) United States
(12) Patent Application Publication
(10) Pub. No.: US 2007/0135286 A1
(43) Pub. Date: Jun. 14, 2007

(54) Device and method for driving cam masks in a folder

(75) Inventors: Joseph Adrian St. Ours, Lee, NH (US); Mark Anthony Wingate, New Durham, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/299,480

(22) Filed: Dec. 12, 2005

(51) Int. Cl. B31F 1/10

(52) U.S. Cl. 493/424

(57) ABSTRACT

The present invention provides a folder having a collect cylinder mounted for rotation and a collect cylinder drive mechanism for rotating the collect cylinder. The collect cylinder includes at least one gripper and a gripper actuator connected to the gripper, and including a cam follower arrangement. A fixed cam having a surface profile is in engagement with the cam follower arrangement to cause actuation of the gripper, and a rotating cam mask is mounted for rotation relative to the fixed cam to selectively mask the surface profile of the fixed mask for actuation of the gripper in a preselected mode. According to a feature of the present invention, an independent cam mask drive mechanism is provided for rotating the rotating cam mask in a controlled rotation to selectively mask the surface profile.

### BACKGROUND

The present invention relates generally to folders for printing presses.

A collect cylinder for use with, for example, a folder mechanism, is used to feed products such as sheets of varying sizes, to the folder. The collect cylinder is typically arranged to selectively feed, for example, sheets in a straight delivery feed, a two collect delivery, a three collect delivery, and so on. A straight delivery is the delivery of a single sheet at a time to a downstream operation. A two collect refers to a delivery of two sheets at a time, and a three collect involves a delivery of three sheets at a time. The collect cylinder includes gripping mechanisms that are actuated to grip the sheets during rotation. Actuation of the gripping mechanisms is typically caused by a cam follower that engages a non-rotating cam mounted adjacent to the rotating collect cylinder. The cam has a surface configuration that can be used to actuate the gripper mechanisms at appropriate times during rotation such that the cylinder grips the appropriate number of sheets for delivery. To that end, a rotating mask is arranged to rotate about an axis coincident with the axis of the collect cylinder, and is used to selectively mask sections of the cam for a controlled operation in one of a straight delivery, two collect delivery or three collect delivery mode.

U. S. Patent No. 4,381,106, hereby incorporated by reference herein, describes a known arrangement for a collect cylinder having a non-rotating cam and a rotating cam mask. A gripper for gripping a product is opened and closed by a cam follower that engages a cam surface of a fixed, non-rotating cam. The cam surface is profiled to coordinate the gripper opening and closing operations with the location of the gripper at product taking and product release stations respectively. A rotating mask has camming surfaces that selectively mask the surface profile of the cam, to thereby permit or prevent operation of the gripper, to provide a selected mode of operation.

In known collect cylinder arrangements of the type described in U. S. Pat. No. 4,381,106, the masks are continuously driven in a rotary motion via the drive gears for the rotating collect cylinder. An adjustable reduction gear arrangement transfers a rotational drive from the cylinder drive gear to the mask. The adjustment of the gear arrangement is controlled to change a gear ratio to thereby change the speed of rotation of the mask. The speed of rotation of the mask determines the operation of the gripper, and thus whether the mask causes a masking of the surface profile of the fixed cam, to thereby provide a straight delivery, two collect delivery or three collect delivery mode. In addition, the mask is rotated to a specific phase relationship with the fixed cam, prior to an operation, such that the rotation of the mask properly masks the profile.

Referring to FIG. 1, there is shown a schematic diagram of a prior art drive arrangement for a rotating mask. A collect and transfer cylinder 10 is mounted for rotation on a cylinder drive shaft 12. A cylinder drive gear 14 is mounted at an end of the cylinder drive shaft 12, and is further coupled to a cylinder drive mechanism, such as an electric motor 15, to thereby rotate the drive shaft 12, and with it, the transfer cylinder 10. A gripper mechanism 16 comprises a plurality of gripping elements 18 rotatably mounted on the transfer cylinder 10. To that end, a lever 20 is attached to an end of the gripper mechanism 16 such that movement of the lever 20 causes the gripping elements to rotate between open and closed, gripping positions.

According to the known illustrated design, a fixed cam 22 and a rotating cam mask 24 are each mounted proximate the lever 20. A pair of cam followers 26, 28 is mounted at an end of the lever 20. The lever 20 is biased to cause the cam follower 26 into engagement with the surface of the fixed cam 26, and the cam follower 28 into engagement with the surface of the rotating cam mask 24. Thus, as the transfer cylinder 10 is rotated by the drive shaft 12, the cam followers 26, 28 move along the surface of the fixed cam 22 and rotating cam mask 24, respectively.

The fixed cam 22 and rotating cam mask 24 have surface profiles (which may for example be similar to those in U.S. Pat. No. 4,381,106) that cause the cam followers 26, 28 to move laterally relative to the cam surface during movement along the respective surface. The radial movement of the cam followers 26, 28 results in movement of the lever 20 to actuate the gripper mechanism 16. The profiles of the fixed cam 22 and rotating cam mask 24 are designed to complement one another in a manner to selectively provide gripper actuation for operation in one of the straight delivery, two collect delivery or three collect delivery modes discussed above.

To that end, the rotating cam mask 24 is mounted on a mask drive shaft 30 that is, in turn, rotatably mounted on the cylinder drive shaft 12. A gear train 32, 34, 36 couples the mask drive shaft 30 to the cylinder drive gear 14. The rotational speed of the rotating cam mask 24 is set at an amount such that the rotating profile of the cam mask 24 properly complements the profile of the fixed cam 22. Additional gears 38, 40 couple the mask drive shaft 30 to a mask phasing handwheel 42. The mask phasing handwheel 42 is used by an operator to manually position the rotating cam mask 24 in a proper phase alignment with the fixed cam 22, for proper operation of the mask 24. Gear 36 may be a planet carrier gear interacting with a sun gear connected to gear 14 and with gear 38 acting as a ring gear.

As can be clearly seen in the prior art illustrated in FIG. 1, the gear arrangement used to drive the rotating mask 24 requires considerable space in the equipment housing. Moreover, phasing of the mask by way of the manual hand manipulation of the mask phasing handwheel 42 is a tedious, time-consuming operation.

In U.S. Pat. No. 4,381,106, the masking gear ratio may be altered using a control knob and an axially-shiftable double gear.

Accordingly, pursuant to known rotating mask designs, the masks are continuously driven via complex gearing. This results in unnecessary wear on the equipment and poor energy conservation. Moreover, the gear arrangements take up valuable space in the gear housing, and require initial timing, re-timing and phase adjustment operations that are critical and tedious. The use of the reduction gear arrangement as a drive mechanism for the rotating masks is also a costly component of the overall cost of the equipment.

### BRIEF SUMMARY OF THE INVENTION

The present invention provides a folder comprising a rotating cylinder having a selectively actuatable printed product contacting device for contacting a printed material on the cylinder, and a cam follower arrangement connected to the paper contacting device. A fixed cam having a surface profile is in engagement with the cam follower arrangement to cause actuation of the printed product contacting device, and a rotating cam mask is mounted for rotation relative to the fixed cam to selectively mask the surface profile of the fixed mask for actuation of the printed product contacting device in a preselected mode. An independent cam mask drive mechanism is provided for rotating the rotating cam mask in a controlled rotation to selectively mask the surface profile.

The present invention also provides a folder with a collect cylinder mounted for rotation and a collect cylinder drive mechanism for rotating the collect cylinder. The collect cylinder includes at least one gripper and a gripper actuator connected to the gripper, and including a cam follower arrangement. A fixed cam having a surface profile is in engagement with the cam follower arrangement to cause actuation of the gripper, and a rotating cam mask is mounted for rotation relative to the fixed cam to selectively mask the surface profile of the fixed mask for actuation of the gripper in a preselected mode. According to a feature of the present invention, an independent cam mask drive mechanism is provided for rotating the rotating cam mask in a controlled rotation to selectively mask the surface profile.

In a further exemplary embodiment of the present invention, a method for operating a collect and transfer cylinder arrangement is provided. The method includes the steps of providing a collect cylinder drive mechanism for rotating the collect cylinder, providing a cam mask drive mechanism for rotating the rotating cam mask in a controlled rotation to selectively mask the surface profile, and operating the collect cylinder drive mechanism independently from the cam mask drive mechanism.

### BRIEF DESCRIPTION OF THE DRAWINGS

FIG. 1 is a schematic diagram of a prior art drive arrangement for a rotating mask;

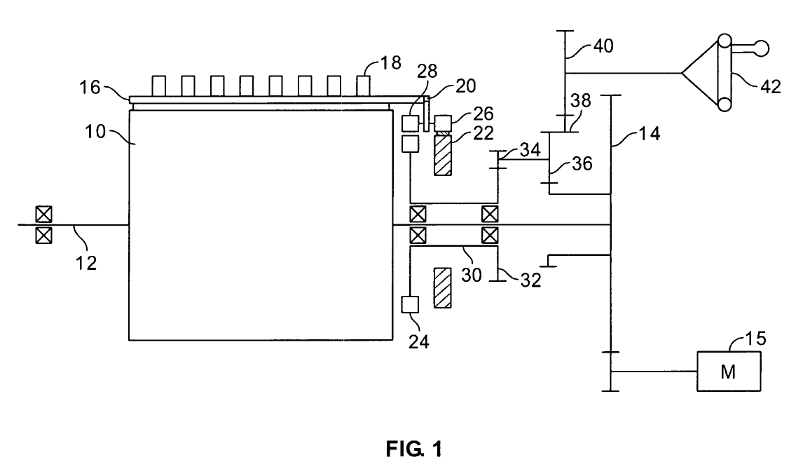

FIG. 2 is a schematic diagram of a folder according to one embodiment of the present invention;

FIG. 3 is a partial side view in more detail of the rotating mask drive according to the FIG. 2 embodiment; and

FIG. 4 is a view of the cam profile and cam mask profile in a stationary parked position according to the present invention.

### DETAILED DESCRIPTION OF A PREFERRED EMBODIMENT

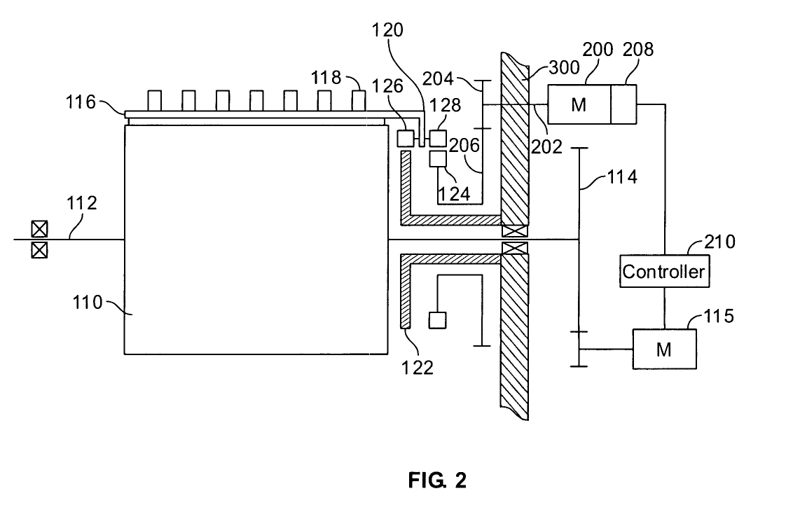

Referring now to FIG. 2, there is shown a schematic diagram of a rotating mask drive according the present invention. The basic construction of the transfer cylinder 110, cylinder drive shaft 112, cylinder drive gear 114, gripper mechanism 116 (including gripper elements 118, lever 120 and cam followers 126 and 128) may be similar as in the prior art arrangement described above or in incorporated-by-reference U.S. Pat. No. 4,381,106. It should be understood that the cylinder 110 may have tuckers and two input shafts, one for the gripper spider and one for the tucker spider, as described for example in U.S. Pat. No 4,381,106. A stationary cam 122 may be supported by a frame 300 and cam follower 126 may be spring-loaded against the cam 122. An angle-controlled motor 115 may drive the gear 114.

An independent rotating cam mask drive mechanism, such as an electric motor 200 supported on frame 300, includes a drive shaft 202 coupled to a drive gear 204 that is in a meshing engagement with a gear 206 supporting a rotating cam mask 124. Thus, the drive mechanism for the rotation of the cam mask 124 is independent of the drive mechanism for the rotation of the transfer cylinder 110, i.e., the drive mechanism for the cam mask is not mechanically coupled to the drive mechanism for the cylinder 110.

Pursuant to a feature of the present invention, an absolute encoder 208 is operatively coupled to the motor 200 to aid control of motor operation. The absolute encoder 208 can provide for example 1000 signals for each rotation, so that the angle of the cam mask 124 may be set or controlled by the controller 210 to a degree of accuracy within 0.36 degrees. The controller 210 can also receive an input as to the angular position of the cylinder 110, for example via a sensor on gear 114 or an encoder on motor 115. It should be understood that motor 115 may be the overall drive motor for a printing press, or an independent drive motor for the cylinder 110 or folder. Controller 210 may also control motor 115 to set the proper mode.

The encoder 208 and cylinder 110 position information permits a controller 210, to rotate the cam mask 124 for proper collect mode phasing with the fixed cam, and then for driving the rotating cam mask 124 at a proper speed for one of the straight delivery, two collect delivery or three collect delivery modes. The controller 210 thus can set the rotational speed and phase of the cam mask 124 with respect to the rotational speed of the cylinder 110. As described for example in U.S. Pat. No. 4,381,106, the mask speed may for example be desired to be five-sixths or five-fourths of the cylinder speed for some modes of operation, and mask phasing may be desired to be altered. The phasing change with the present invention may occur on the fly by speeding or slowing the motor 200 with respect to motor 115 at a known rate over a known period of time.

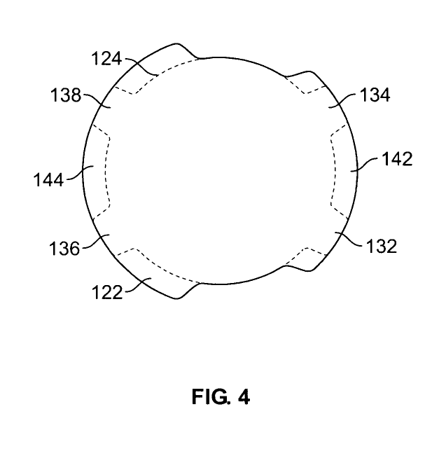

As described with reference in FIG. 4, the controller 210 can also move the cam mask 124 to an angular position where the cam follower arrangement is unaffected by the cam mask 124 (i.e. the masking surfaces 132, 134, 136 and 138 are coaxial and coextensive with arcuate holding surfaces 142 and 144 so that no masking occurs). The motor 200 then can be turned off in a non-masking orientation during times when no masking is required. This can permit the motor 200 not to be operated at all and reduce energy and wear. Cam 122 thus preferably has a profile which corresponds to one of the desired modes, for example straight mode, so that no masking is required in that mode.

Thus, with the features of the present invention, there will be a more efficient operation for the transfer cylinder arrangement, with better power conservation and reduced wear on the rotating cam mask parts. Moreover, the overall cost of the transfer cylinder equipment is significantly reduced.

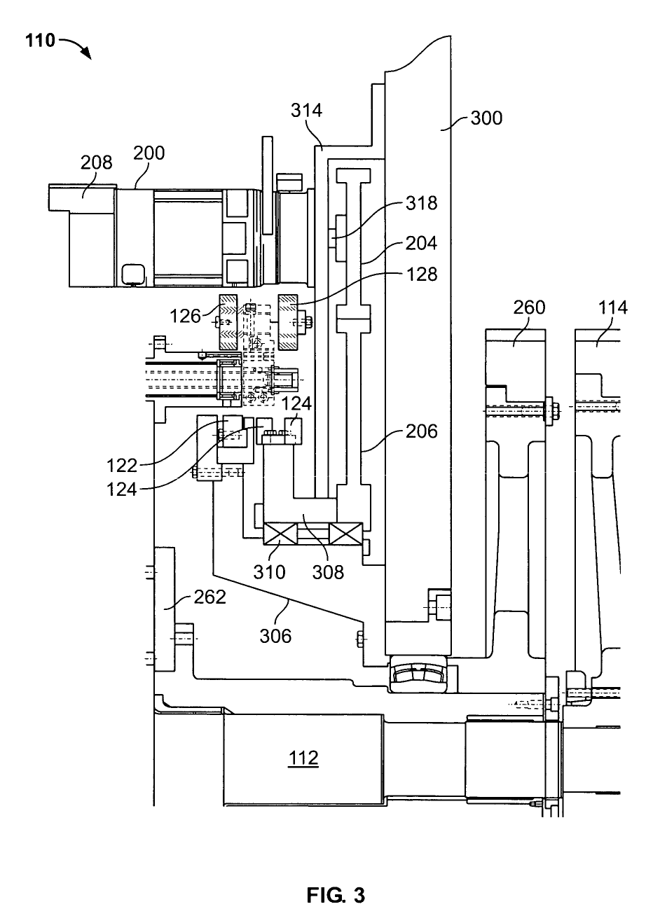

FIG. 3 shows more detail of the mask drive gearing described in FIG. 2. A frame 300 has an extension 314 for supporting motor 200 and a support arm 306 supporting fixed cam 122. Rotating cam mask 124 is mounted on a support collar 308, which is, in turn, mounted for rotation on the support arm 306 by bearings 310. Cam mask drive gear 206 is also rotatably supported by bearings 310.

An output shaft 318 of the motor 200 mounts a gear 204 arranged in a meshing engagement with the cam mask drive gear 206 for an independent rotary drive to the drive gear 206 to cause rotation of the cam mask 124.

Motor 115 shown in FIG. 2 may drive via both the cylinder 110 via input gears 114 and 260. Gear 260 may drive a gripper spider 262 as described or example in U.S. Pat. No. 4,381,106, and gear 114 may drive a tucker spider. The phase between the gripper spider 262 and the tuckers may be altered for different product configurations.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense. In particular, it should be understood that the printed product contacting device could be a gripper, a pin, a jaw or a tucker of a folder.

1. A folder comprising:
a collect cylinder mounted for rotation;
a collect cylinder drive mechanism for rotating the collect cylinder;
the collect cylinder including at least one gripper;
a gripper actuator connected to the gripper, the gripper actuator including a cam follower arrangement;
a fixed cam having a surface profile for engagement with the cam follower arrangement to cause actuation of the gripper;
a rotating cam mask mounted for rotation relative to the fixed cam to selectively mask the surface profile of the fixed mask for actuation of the gripper in a preselected mode; and
a cam mask drive mechanism mechanically independent of the collect cylinder drive mechanism for rotating the rotating cam mask in a controlled rotation to selectively mask the surface profile.

2. The folder as recited in claim 1 wherein the independent cam mask drive mechanism comprises an electric motor.

3. The folder as recited in claim 2 wherein the electric motor includes an encoder for determining an angular position of the motor.

4. The folder as recited in claim 3 further comprising a controller receiving an input from the encoder.

5. The folder as recited in claim 4 wherein the preselected mode is one of a straight delivery, two collect delivery or three collect delivery mode.

6. The folder as recited in claim 5 wherein the controller controls the motor to rotate the rotating cam mask for proper collect mode phasing with the fixed cam.

7. A method for operating a folder having a collect and transfer cylinder including a collect cylinder mounted for rotation, the collect cylinder including at least one gripper, a gripper actuator connected to the gripper, the gripper actuator including a cam follower arrangement, a fixed cam having a surface profile for engagement with the cam follower arrangement to cause actuation of the gripper, and a rotating cam mask mounted for rotation relative to the fixed cam to selectively mask the surface profile of the fixed mask for actuation of the gripper in a preselected mode, the method comprising the steps of:
providing a collect cylinder drive mechanism for rotating the collect cylinder;
providing a cam mask drive mechanism for rotating the rotating cam mask in a controlled rotation to selectively mask the surface profile; and
electronically controlling the cam mask drive mechanism as a function of the speed of the collect cylinder drive mechanism.

8. The method of claim 7 comprising the further step of operating the cam mask drive mechanism to be in one of a straight delivery, two collect delivery or three collect delivery mode.

9. The method of claim 7 comprising the further step of operating the cam mask drive mechanism to rotate the rotating cam mask for proper collect mode phasing with the fixed cam.

10. A folder comprising:
a rotating cylinder having a selectively actuatable printed product contacting device for contacting a printed material on the cylinder;
a cam follower arrangement connected to the printed product contacting device; a fixed cam having a surface profile in engagement with the cam follower arrangement to cause actuation of the printed product contacting device;
a rotating cam mask mounted for rotation relative to the fixed cam to selectively mask the surface profile of the fixed mask for actuation of the printed product contacting device in a preselected mode; and
a cam mask drive mechanism independent mechanically from the rotating cylinder for rotating the rotating cam mask in a controlled rotation to selectively mask the surface profile.

11. A method for driving a cam mask in a folder comprising:
driving the cam mask using an angle-controlled motor mechanically independent from a drive of the folder.

12. The method as recited in claim 11 further comprising turning off the angle-controlled motor during at least one preselected mode, the cam mask being stopped during the preselected mode.
